(19) United States
(12) Patent Application Publication
(10) Pub. No.: US 2010/0175766 A1
(43) Pub. Date: Jul. 15, 2010

(54) REMOTE CONTROL WATER METER

(76) Inventor: JOHN A. LICHMAN, West Chester, PA (US)

Correspondence Address: James Ray & Associates, 2640 Pitcairn Road, Monroeville, PA, 15146, US

(21) Appl. No.: 12/687,342

(22) Filed: Jan. 14, 2010

Related U.S. Application Data
(60) Provisional application No. 61/144,862, filed on Jan. 15, 2009.

(51) Int. Cl. F16K 31/48; F16K 31/02

(52) U.S. Cl. 137/624.12; 251/129.04

(57) ABSTRACT

The present invention an apparatus and system for remotely operating a combination water meter and shut off valve. The apparatus and system is operated by a computer at the utility sending a signal via phone line or radio modem to the meter. Once the meter receives the signal to close, a small solenoid will open. This will allow water to enter the fill chamber, causing the piston to rise. The top of the piston is connected to a gate valve. This valve may turn off the water supply to a customer's home. To turn the water back on, a signal can be sent again to the meter, opening the drain solenoid. This allows the water to leave the fill chamber. The piston is then lowered from the return spring, opening the gate valve, allowing water to flow.

### CROSS REFERENCE TO RELATED APPLICATION

This patent application is related to and claims priority from U.S. Provisional Patent Application Ser. No. 61/144,862 filed Jan. 15, 2009.

### FIELD OF THE INVENTION

This invention generally pertains to fluid metering and fluid valve systems. Specifically, the present invention relates to a remote control water meter and water shut off valve.

### BACKGROUND OF THE INVENTION

The invention is particularly applicable to water utility meters and will be described with particular reference thereto. However, it will be appreciated by those skilled in the art that the invention has broader applications and may also be adapted for use in gas, natural gas, propane, oil, heating oil, other fluid utility systems, other water systems and other fluid systems.

Non-payment of utility bills may result in a customer's water supply being halted. In order to do so, the water company may have to pay for a person and a vehicle to travel to the building to manually turn off the water. Having a simple way to remotely turn off the water may assist water companies in reducing expenses while increasing the productivity of existing man hours.

### SUMMARY OF THE INVENTION

The present invention in several embodiments is a system that would give water utilities an easy and effective way to turn off the water at a certain building if the owners were to not pay or for other reasons. This unique product can assist companies in cutting costs by not having to send out employees to manually turn on or off the water. This innovative item is ideal for use in any building with a water supply for a fast and effective way to stop the flow of water. This unit may also be beneficial in giving water companies a way to quickly isolate water in customers' homes in the event of a serious water safety issue, such as water leaks, water contamination, and terrorism.

The present invention in several embodiments is an arrangement of components that work together to provide water companies with an automated way to turn off the water supply of a building for various reasons. This product may be comprised of a standard water meter, micro- solenoid valves, a piston chamber, return spring and a gate valve. This product works by a computer at the utility sending a signal via phone line or radio modem to the meter. Once the meter receives the signal to close, a small solenoid will open. This will allow water to enter the fill chamber, causing the piston to rise. The top of the piston is connected to a gate valve. This valve may turn off the water supply to a customer's home. The drain solenoid may be covered by a lockbox to prevent tampering. To turn the water back on, a signal can be sent again to the meter, opening the drain solenoid. This allows the water to leave the fill chamber. The piston is then lowered from the return spring, opening the gate valve, allowing water to flow. This unit may measure approximately 6″ high, 10″ long and 5″ wide. The exact dimensions, materials used for construction and method of operation of may vary upon manufacturing.

### OBJECTS OF THE INVENTION

It is, therefore, one of the primary objects of the present invention to provide a remotely controlled water meter.

Another object of the present invention is to provide a remotely controlled water valve.

Still another object of the present invention is to provide a remotely controlled water valve that has lower electrical requirements than other designs.

Yet still another object of the present invention is to provide a remotely controlled water meter that has lower electrical requirements than other designs.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a general perspective view of the exterior of one embodiment of the present invention.

FIG. 2 is a close up top view of one embodiment of the present invention.

FIG. 3 is a close up cutaway view of the shut off valve assembly.

FIG. 4 is a cutaway view of one embodiment of the present invention.

FIG. 5 is a cutaway view of one embodiment of the present invention with the shut off valve closed.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

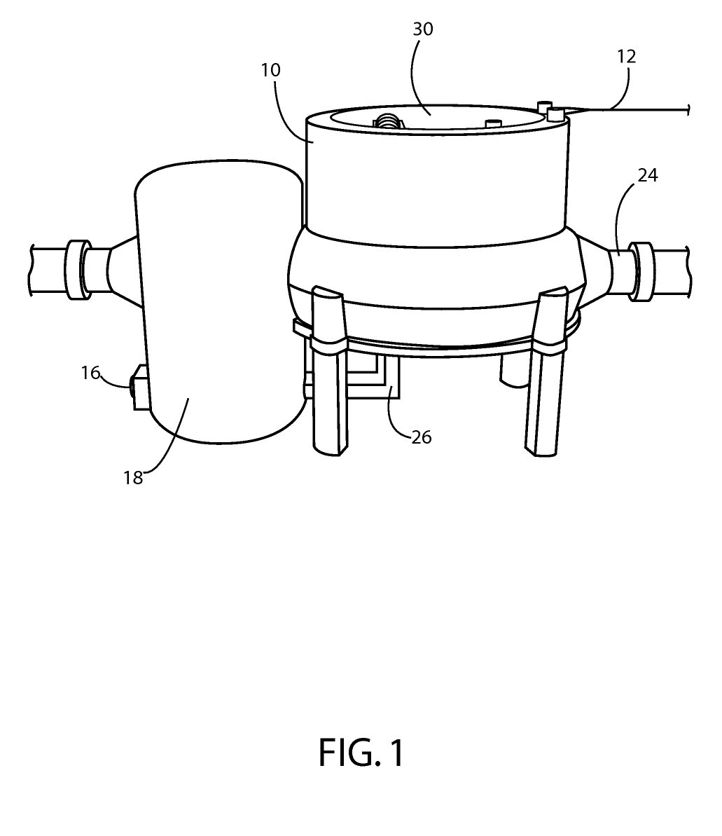

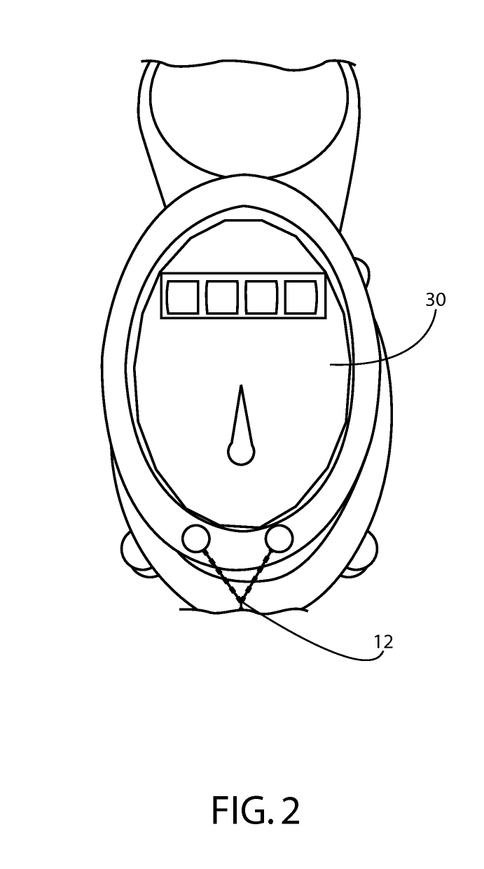

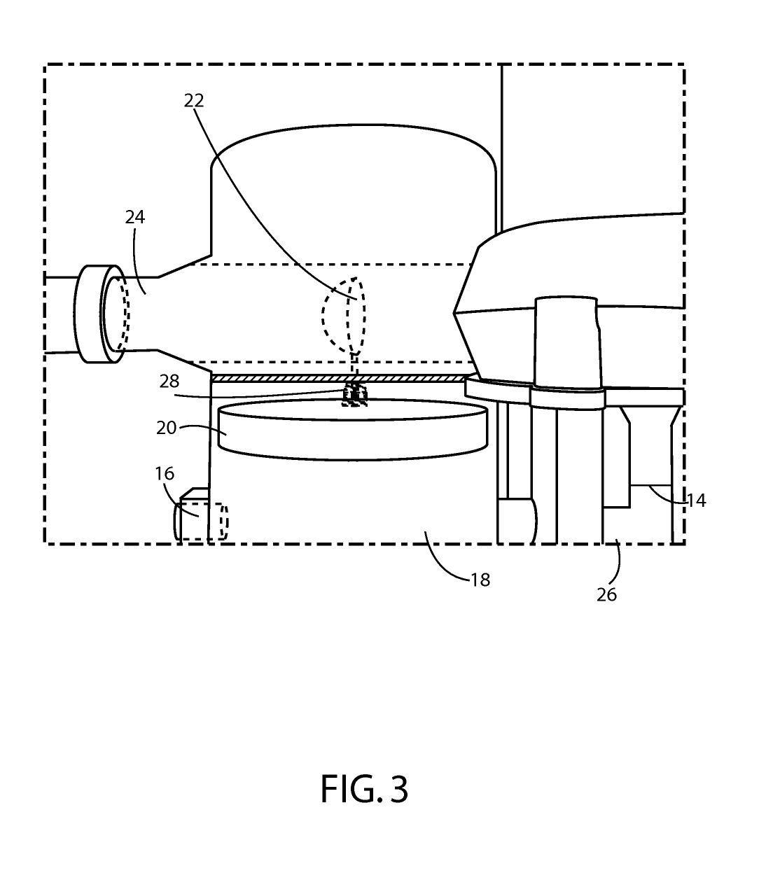

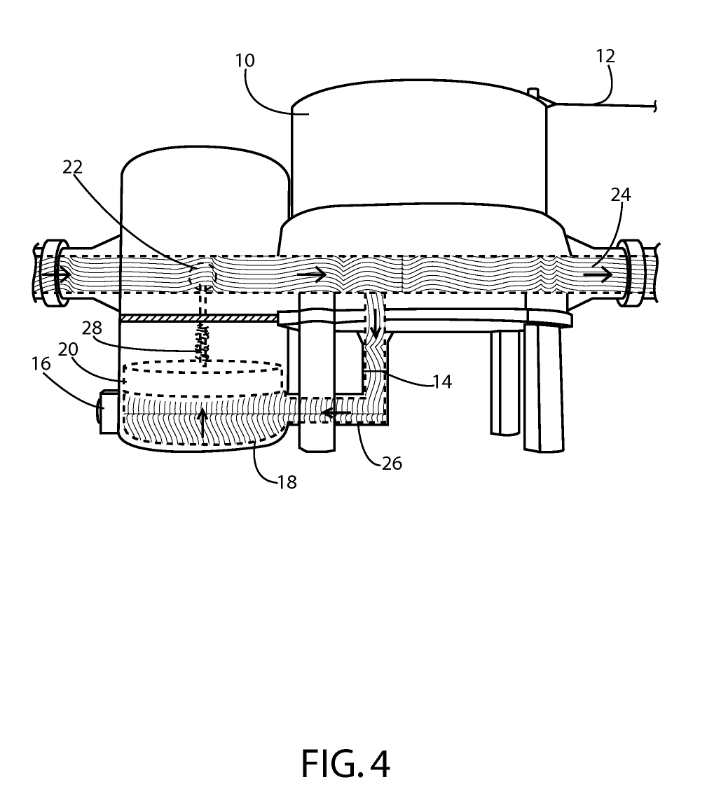

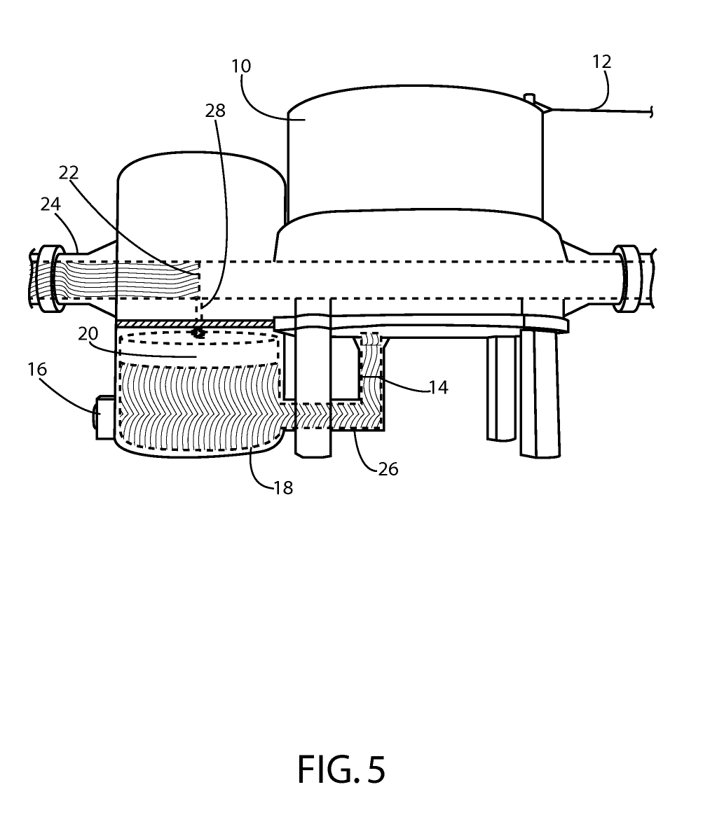

Reference is now made to FIGS. 1-5 which show several views of a preferred embodiment of the present invention. The present invention in several embodiments is a remotely controlled water meter, comprising a standard water meter 10 in electrical communication with a phone line 12, a fill solenoid 14, a drain solenoid 16, a fill chamber 18 with a piston 20, a shut off valve 22, water supply line 24, water chamber line 26, return spring 28, and water meter display 30.

During in service operations, utility water moves through water supply line 24, with fill solenoid 14 in a closed position and drain solenoid 16 preferably in an open position. To shut off the utility water supply fill solenoid 14 is opened and drain solenoid 16 is closed, thereby filling fill chamber 18 with water which causes piston 20 to move and close shut off valve 22. Shut off valve could be any suitable valve known in the art including ball valves, butterfly valve, or the like. Preferably, shut off valve 22 is a gate valve and is shown as such in the drawings. To re-open the shut off valve 22 the fill solenoid 14 is put in a closed position and drain solenoid 16 is put in an open position, thus draining the water from the fill chamber 18.

The solenoids and other electrical components of the present invention could be powered by means of a phone line or suitable battery system. Since the water pressure of the water supply line 24 is used to close the shut off valve 22, by means of fill chamber 18 and piston 20, very little power is used by the present invention. The solenoids could be any suitable solenoid known in the art, but preferably the solenoids are micro-solenoids. While not shown in the drawings the solenoids are electrically connected, though not directly, to phone line 12 or a battery to actuate the solenoids.

Communication and control of the present invention can be accomplished in many ways, but in a preferred embodiment phone line 12 provides the control signals for the present invention. This allows for remote control of the present invention by means of the phone system. The present invention could also comprise wireless communication means instead of or in addition to phone line communication. The additional wireless communication means could allow for on site or off site wireless control of the present invention.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A water meter comprising:
a water meter,
a shut off valve,
wherein said shut off valve is operated remotely.

2. The water meter of claim 1, wherein: said shut off valve is operated remotely by means of a phone line communication.

3. The water meter of claim 1, wherein: said shut off valve is operated remotely by means of a wireless communication.

4. The water meter of claim 1, wherein: said shut off valve is at least in part actuated by means of a piston in fluid communication with a water line.

5. The water meter of claim 1, further comprising:
at least one electronic communication means,
at least one solenoid,
wherein said shut off valve is at least in part actuated by means of a piston in fluid communication with a water line.

6. The water meter of claim 1, further comprising:
at least one phone line communication,
at least one solenoid,
wherein said shut off valve is at least in part actuated by means of a piston in fluid communication with a water line, and said at least one phone communication powers said at least one solenoid.

7. The water meter of claim 5, wherein said at least one electronic communication means is a radio frequency (RF) wireless communication means.

8. The water meter of claim 5, wherein said at least one solenoid is powered by at least one battery.

9. A water meter comprising:
a water meter,
a shut off valve,
at least one phone line communication,
at least two solenoids,
a piston in fluid communication with a water line,
wherein said shut off valve is operated remotely by means of said at least one phone line communication.
